(19) United States
(12) Patent Application Publication
(10) Pub. No.: US 2014/0158085 A1
(43) Pub. Date: Jun. 12, 2014

(54) Six-Stroke Combustion Cycle Engine and Process

(71) Applicant: CATERPILLAR INC., Peoria, IL (US)

(72) Inventors: D. Ryan Williams, Edwards, IL (US); Scott B. Fiveland, Metamora, IL (US)

(73) Assignee: CATERPILLAR INC., Peoria, IL (US)

(21) Appl. No.: 13/711,785

(22) Filed: Dec. 12, 2012

(51) Int. Cl. F02B 75/02

(52) U.S. Cl. CPC F02B 75/021
USPC 123/294

(57) ABSTRACT

An internal combustion engine operates on a six-stroke combustion cycle including a first compression stroke, a first power stroke, a second compression stroke, and a second power stroke. A first preliminary fuel charge is introduced to a combustion chamber of the engine during the first compression stroke. Subsequently, a first main fuel charge is introduced and the first preliminary and first main fuel charges are combusted to power the first power stroke. During the second compression stroke, a second preliminary fuel charge is introduced to the combustion chamber. Subsequently, a second main fuel charge is introduced during one of the second compression stroke and second power stroke. The second preliminary and second main fuel charges are combusted to power the second power stroke.

### TECHNICAL FIELD

This patent disclosure relates generally to internal combustion engines and, more particularly, to internal combustion engines that are configured to operate on a six-stroke internal combustion cycle.

### BACKGROUND

Internal combustion engines operating on a six-stroke cycle are generally known in the art. In a six-stroke cycle, a piston reciprocally disposed in a cylinder moves through an intake stroke from a top dead center (TDC) position to a bottom dead center (BDC) position to admit air, an air/fuel mixture, and/or an air/exhaust gas mixture into the cylinder. During a compression stroke, the piston moves towards the TDC position to compress the air or the air/fuel/exhaust gas mixture. During this process, an initial or additional fuel charge may be introduced to the cylinder by an injector. Ignition of the compressed mixture increases the pressure in the cylinder and forces the piston towards the BDC position during a first power stroke. In accordance with the six-stroke cycle, the piston performs a second compression stroke in which it recompresses the combustion products remaining in the cylinder after the first combustion or power stroke. During this recompression, any exhaust valves associated with the cylinder remain generally closed to assist cylinder recompression. Optionally, a second fuel charge may be introduced into the cylinder during recompression to assist igniting the residual combustion products and produce a second power stroke. Following the second power stroke, the cylinder undergoes an exhaust stroke with the exhaust valve or valves open to substantially evacuate combustion products from the cylinder. One example of an internal combustion engine configured to operate on a six-stroke engine can be found in U.S. Pat. No. 7,418,928. This disclosure relates to a method of operating an engine that includes compressing part of the combustion gas after a first combustion stroke of the piston as well as an additional combustion stroke during a six-stroke cycle of the engine.

Some possible advantages of the six-stroke cycle over the more common four-stroke cycle can include reduced emissions and improved fuel efficiency. For example, the second combustion event and second power stroke can provide for a more complete combustion of soot and/or fuel that may remain in the cylinder after the first combustion event. However, the additional piston strokes and fuel charges may increase the complexity of the internal combustion engine and its operation. The present disclosure is directed to addressing the increased complexity of the engine.

### SUMMARY

In one aspect, the disclosure describes a method of operating an internal combustion engine using a six-stroke cycle having a first intake stroke, a first compression stroke, a first power stroke, a second compression stroke, a second power stroke and an exhaust stroke. The method introduces a first preliminary fuel charge to a combustion chamber of the internal combustion engine during the first compression stroke. Subsequent to the first preliminary fuel charge, the method introduces a first main fuel charge to the combustion chamber during at least one of the first compression stroke and the first power stroke. The first preliminary fuel charge and first main fuel charge are combusted to power the first power stroke. The method next introduces a second preliminary fuel charge to the combustion chamber during the second compression stroke and a second main fuel charge to the combustion chamber during at least one of the second compression stroke and the second power stroke. The second preliminary fuel charge and second main fuel charge are combusted to power the second power stroke.

In another aspect, the disclosure describes an internal combustion engine system also operating on a six-stroke cycle with an intake stroke, a first compression stroke, a first power stroke, a second compression stroke, a second power stroke, and an exhaust stroke. The engine system includes a combustion chamber with a cylinder and a piston reciprocally disposed in the cylinder to move between a top dead center position (TDC) and a bottom dead center position (BDC). The piston is connected to a rotatable crankshaft rotating between 0 degrees at the start of the intake stroke and 1080 degrees at the end of the exhaust stroke. The engine system also includes a fuel injector in fluid communication with the combustion chamber to introduce fuel to the cylinder. A controller is operatively associated with the engine and controls the injector to introduce a first preliminary fuel charge and a first main fuel charge during the first compression stroke. The control further directs the injector to introduce a second preliminary fuel charge during the second compression stroke and to introduce a second main fuel charge during at least one of the second compression stroke and the second power stroke.

In yet another aspect, the disclosure describes a method of balancing first and second combustion events in an internal combustion engine operating on a six stroke cycle. The six-stroke cycle includes an intake stroke, a first compression stroke, a first combustion event and a first power stroke, a second compression stroke, a second combustion event and a second power stroke, and an exhaust stroke. According to the method, a combustion chamber is provided that has a piston reciprocally movable in a cylinder between a top dead center position and a bottom dead cylinder position. The method introduces a first main fuel charge to a combustion chamber during the first compression stroke before the piston reaches the TDC position. A preliminary fuel charge is then introduced to the combustion chamber during the second compression stroke before the piston reaches the TDC position and a second main fuel is introduced to the combustion chamber during the second power stroke after the piston reaches the TDC position.

### BRIEF DESCRIPTION OF THE DRAWINGS

FIG. 1 is a block diagram of an engine system having an internal combustion engine adapted for operation in accordance with a six-stroke combustion cycle and certain associated systems and components for assisting the combustion process.

FIGS. 2-10 are cross-sectional views representing an engine cylinder and a piston movably disposed therein at various points during a six-stroke combustion cycle.

FIG. 11 is a chart representing the lift of the intake valve or valves and exhaust valve or valves in millimeters along the Y-axis as measured against crankshaft angle in degrees along the X-axis for a six-stroke combustion cycle.

FIG. 12 is a chart illustrating a comparison of the internal cylinder pressure along the Y-axis in kilopascals (kPa) as measured against crankshaft angle along the X-axis as measured in degrees for a six-stroke combustion cycle.

FIG. 13 is a graph illustrating the distribution of fuel quantities introduced to the combustion chamber as a percentage of the total cycle fuel charge along the Y-axis during the six-stroke combustion cycle as measured against crankshaft angle along the X-axis.

FIG. 14 is a cross-sectional view of an embodiment of fuel injector for introducing fuel to the combustion chamber having first and second independently movable checks to seal and unseal selected sets of orifices and produce fuel charges of differing quantities.

FIG. 15 is a schematic flow chart representing a possible routine or steps for operating a six-stroke engine using preliminary fuel charges and main fuel charges.

### DETAILED DESCRIPTION

This disclosure relates in general to an internal combustion engine and, more particularly, to one adapted to perform a six-stroke cycle for reduced emissions and improved efficiencies. Internal combustion engines burn a hydrocarbon-based fuel or another combustible fuel source to convert the potential or chemical energy therein to mechanical power that can be utilized for other work. In one embodiment, the disclosed engine may be a compression ignition engine, such as a diesel engine, in which a mixture of air and fuel are compressed in a cylinder to raise their pressure and temperature to a point at which auto-ignition or spontaneous ignition occurs. Such engines typically lack a sparkplug that is often associated with gasoline burning engines. However, in alternative embodiments, the utilization of different fuels such as gasoline and different ignition methods, for example, use of diesel as a pilot fuel to ignite gasoline or natural gas, are contemplated and fall within the scope of the disclosure.

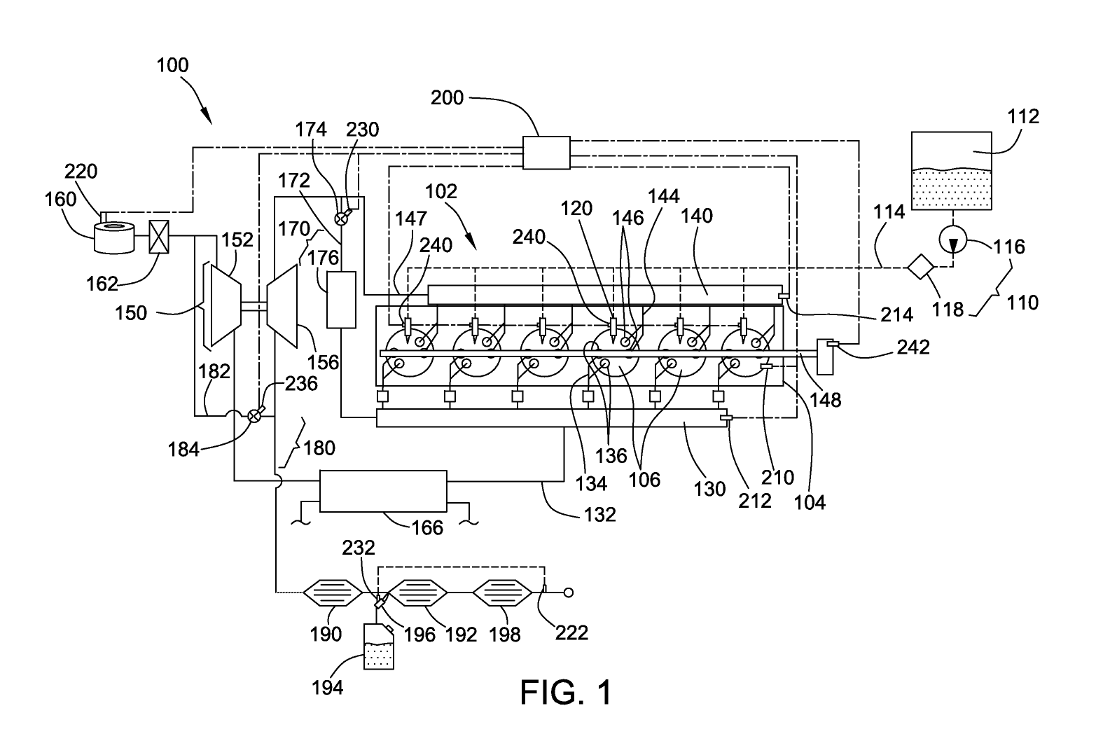

Now referring to FIG. 1, wherein like reference numbers refer to like elements, there is illustrated a block diagram representing an internal combustion engine system 100. The engine system 100 includes an internal combustion engine 102 and, in particular, a diesel engine that combusts a mixture of air and diesel fuel. The illustrated internal combustion engine 102 includes an engine block 104 in which a plurality of combustion chambers 106 are disposed. Although six combustion chambers 106 are shown in an inline configuration, in other embodiments fewer or more combustion chambers may be included or another configuration such as a V-configuration may be employed. The engine system 100 can be utilized in any suitable application including mobile applications such as motor vehicles, work machines, locomotives or marine engines, and in stationary applications such as electrical power generators.

To supply the fuel that the engine 102 burns during the combustion process, a fuel system 110 is operatively associated with the engine system 100. The fuel system 110 includes a fuel reservoir 112 that can accommodate a hydrocarbon-based fuel such as liquid diesel fuel. Although only one fuel reservoir is depicted in the illustrated embodiment, it will be appreciated that in other embodiments additional reservoirs may be included that accommodate the same or different types of fuels that the combustion process may also burn. Because the fuel reservoir 112 may be situated in a remote location with respect to the engine 102, a fuel line 114 can be disposed through the engine system 100 to direct the fuel from the fuel reservoir to the engine. To pressurize the fuel and force it through the fuel line 114, a fuel pump 116 can be disposed in the fuel line. An optional fuel conditioner 118 may also be disposed in the fuel line 114 to filter the fuel or otherwise condition the fuel by, for example, introducing additives to the fuel, heating the fuel, removing water and the like.

To introduce the fuel to the combustion chambers 106, the fuel line 114 may be in fluid communication with one or more fuel injectors 120 associated with the combustion chambers. In the illustrated embodiment, one fuel injector 120 is associated with each combustion chamber but in other embodiments, a different number of injectors per combustion chamber might be used. Additionally, while the illustrated embodiment depicts the fuel line 114 terminating at the fuel injectors 120, the fuel line may establish a fuel loop that continuously circulates fuel through the plurality of injectors and, optionally, delivers unused fuel back to the fuel reservoir 112. Alternatively, the fuel line 114 may include a fuel collector volume or rail (not shown), which supplies pressurized fuel to the fuel injectors 120.

To supply intake air that is combusted with the fuel in the combustion chambers 106, a hollow runner or intake manifold 130 can be formed in or attached to the engine block 104 such that it extends over or proximate to each of the combustion chambers. The intake manifold 130 can communicate with an intake line 132 that directs air to the internal combustion engine 102. Fluid communication between the intake manifold 130 and the combustion chambers 106 can be established by a plurality of intake runners 134 extending from the intake manifold. One or more intake valves 136 can be associated with each combustion chamber 106 and can open and close to selectively introduce the intake air from the intake manifold 130 to the combustion chamber. While the illustrated embodiment depicts the intake valves at the top of the combustion chamber 106, in other embodiments, the intake valves may be placed at other locations such as through a sidewall of the combustion chamber. To direct exhaust gasses produced by combustion of the air/fuel mixture out of the combustion chambers 106, an exhaust manifold 140 communicating with an exhaust line 142 can also be disposed in or proximate to the engine block 104. The exhaust manifold 140 can communicate with the combustion chambers 106 by exhaust runners 144 extending from the exhaust manifold. The exhaust manifold 140 can receive exhaust gasses by selective opening and closing of one or more exhaust valves 146 associated with each combustion chamber 106.

To actuate the intake valves 136 and the exhaust valves 146, the illustrated embodiment depicts an overhead camshaft 148 that is disposed over the engine block 104 and operatively engages the valves. As will be familiar to those of skill in the art, the camshaft 148 can include a plurality of eccentric lobes disposed along its length that, as the camshaft rotates, cause the intake and exhaust valves 136, 146 to displace or move up and down in an alternating manner with respect to the combustion chambers 106. Movement of the valves can open and close ports leading into the combustion chamber. The placement or configuration of the lobes along the camshaft 148 controls or determines the gas flow through the internal combustion engine 102. As is known in the art, other methods exist for implementing valve timing such as actuators acting on the individual valve stems and the like. Furthermore, in other embodiments, a variable valve timing method can be employed that adjusts the timing and duration of actuating the intake and exhaust valves during the combustion process to simultaneously adjust the combustion process.

To assist in directing the intake air into the internal combustion engine 102, the engine system 100 can include a turbocharger 150. The turbocharger 150 includes a compressor 152 disposed in the intake line 132 that compresses intake air drawn from the atmosphere and directs the compressed air to the intake manifold 130. Although a single turbocharger 150 is shown, more than one such device connected in series and/or in parallel with another can be used. To power the compressor 152, a turbine 156 can be disposed in the exhaust line 142 and can receive pressurized exhaust gasses from the exhaust manifold 140. The pressurized exhaust gasses directed through the turbine 156 can rotate a turbine wheel having a series of blades thereon, which powers a shaft that causes a compressor wheel to rotate within the compressor housing.

To filter debris from intake air drawn from the atmosphere, an intake air filter 160 can be disposed upstream of the compressor 152. In some embodiments, the engine system 100 may be open-throttled wherein the compressor 152 draws air directly from the atmosphere with no intervening controls or adjustability. In other embodiments, an adjustable governor or intake throttle 162 can be disposed in the intake line 132 between the intake air filter 160 and the compressor 152. Because the intake air may become heated during compression, an intercooler 166 such as an air-to-air heat exchanger can be disposed in the intake line 132 between the compressor 152 and the intake manifold 130 to cool the compressed air.

To reduce emissions generated by the combustion of air and fuel, the engine system 100 can mix the intake air with a portion of the exhaust gasses drawn from the exhaust system in a system or process referred to as exhaust gas recirculation (EGR). The EGR system forms an intake air/exhaust gas mixture that is introduced to the combustion chambers. In one aspect, addition of exhaust gasses to the intake air displaces the relative amount of oxygen in the combustion chamber during combustion that results in a lower combustion temperature and reduces the generation of nitrogen oxides. Two exemplary EGR systems, a high-pressure EGR system 170 and a low-pressure EGR system 180, are shown associated with the engine system 100 in FIG. 1, but it should be appreciated that these illustrations are exemplary and that either one, both, or neither can be used on the engine. It is contemplated that selection of an EGR system of a particular type may depend on the particular requirements of each engine application.

In the first embodiment, a high-pressure EGR system 170 operates to direct high-pressure exhaust gasses to the intake manifold 130. The high-pressure EGR system 170 includes a high-pressure EGR line 172 that communicates with the exhaust line 142 downstream of the exhaust manifold 140 and upstream of the turbine 156 to receive a portion of the high-pressure exhaust gasses before they've had a chance to depressurize through the turbine. The high-pressure EGR line 172 can direct the exhaust gasses to the intake manifold 130 where they can intermix with the intake air prior to combustion. To control the amount or quantity of the exhaust gasses combined with the intake air, an adjustable EGR valve 174 can be disposed along the high-pressure EGR line 172. Hence, the ratio of exhaust gasses mixed with intake air can be varied during operation by adjustment of the adjustable EGR valve 174. Because the exhaust gasses may be at a sufficiently high temperature that may affect the combustion process, the high-pressure EGR system can also include an EGR cooler 176 disposed along the high-pressure EGR line 172 to cool the exhaust gasses.

In the second embodiment, a low-pressure EGR system 180 includes a low-pressure EGR line 182 that directs low-pressure exhaust gasses to the intake line 132. The low-pressure EGR line 182 communicates with the exhaust line 142 downstream of the turbine 156 so that it receives low-pressure exhaust gasses that have depressurized through the turbine, and delivers the exhaust gasses upstream of the compressor 152 so it can mix and be compressed with the incoming air. The system is thus referred to as a low-pressure EGR system because it operates using depressurized exhaust gasses. To control the quantity of exhaust gasses re-circulated, a second adjustable EGR valve 184 can be disposed in the low-pressure EGR line 182. The exhaust gasses and intake air can be cooled by the intercooler 166 disposed in the intake line 132.

The engine system 100 can include additional after-treatment devices to further reduce emissions from the combustion process. One example of an after-treatment device is a three-way catalyst 190. Three-way catalysts are flow-through devices disposed in the exhaust stream that contain precious metals or other materials to cause or catalyze reactions between certain chemicals in the exhaust gasses and convert them to more environmentally acceptable components. A three-way catalyst can convert nitrogen oxides (NO and NO₂, commonly referred to as NO_{X}), carbon monoxide (CO), and un-combusted fuel in the form of hydrocarbons (HC). Possible representative reactions for a three-way catalyst are:

2NO_{X}→xO₂+N₂ (1)

CO+½O₂→CO₂ (2)

[H_{X}C_{X}]+O₂→xCO₂+xH₂O (3)

Because the reactions in the three-way catalyst are interrelated and rely on specific ratios of reactants, the combustion process must be generally well-regulated to control the composition and components of the exhaust gasses.

Another after-treatment device is a selective catalytic reduction (SCR) catalyst 192 that can convert nitrogen oxides (NO_{X}) in the exhaust with a reductant agent like ammonia or an ammonia precursor such as urea to nitrogen and water. An representative equation can be:

NH₃+NO_{X}=N₂+H₂0 (4)

To provide the reductant agent used in the process, an electrically-operated SCR injector 196 in fluid communication with a separate storage tank 194 can be arranged to introduce reductant agent either into the exhaust line 142 upstream of the SCR catalyst or directly into the SCR catalyst. The process of introducing reductant agent is sometimes referred to as “dosing.” Other optional after-treatment devices 198 include diesel oxidation catalysts (DOC) 198 that convert hydrocarbons and carbon monoxide to carbon dioxide; diesel particulate filters (DPF) that temporarily traps soot, and the like.

To coordinate and control the various systems and components associated with the engine system 100, the system can include an electronic or computerized control unit, module or controller 200. The controller 200 is adapted to monitor various operating parameters and to responsively regulate various variables and functions affecting engine operation. The controller 200 can include a microprocessor, an application specific integrated circuit (ASIC), or other appropriate circuitry and can have memory or other data storage capabilities. The controller can include functions, steps, routines, data tables, data maps, charts and the like saved in and executable from read-only memory or another electronically accessible storage medium to control the engine system. Although in FIG. 1, the controller 200 is illustrated as a single, discrete unit, in other embodiments, the controller and its functions may be distributed among a plurality of distinct and separate components. To receive operating parameters and send control commands or instructions, the controller can be operatively associated with and can communicate with various sensors and controls on the engine system 100. Communication between the controller and the sensors can be established by sending and receiving digital or analog signals across electronic communication lines or communication busses. The various communication and command channels are indicated in dashed lines for illustration purposes.

For example, to monitor the pressure and/or temperature in the combustion chambers 106, the controller 200 may communicate with chamber sensors 210 such as a transducer or the like, one of which may be associated with each combustion chamber 106 in the engine block 104. The chamber sensors 210 can monitor the combustion chamber conditions directly or indirectly. For example, by measuring the backpressure exerted against the intake or exhaust valves, the controller 200 can indirectly measure the pressure in the combustion chamber 106. The controller 200 can also communicate with an intake manifold sensor 212 disposed in the intake manifold 130 and that can sense or measure the conditions therein. To monitor the conditions such as pressure and/or temperature in the exhaust manifold 140, the controller 200 can similarly communicate with an exhaust manifold sensor 214 disposed in the exhaust manifold 140. From the temperature of the exhaust gasses in the exhaust manifold 140, the controller 200 may be able to infer the temperature at which combustion in the combustion chambers 106 is occurring.

To measure the flow rate, pressure and/or temperature of the air entering the engine, the controller 200 can communicate with an intake air sensor 220. The intake air sensor 220 may be associated with, as shown, the intake air filter 160 or another intake system component such as the intake manifold. The intake air sensor 220 may also determine or sense the barometric pressure or other environmental conditions in which the engine system is operating. To measure the quality of the exhaust gasses and/or emissions actually discharged by the engine system 100 to the environment, the controller can communicate with a system outlet sensor 222 disposed in the exhaust line 142 downstream of the after-treatment devices.

The controller 200 can also be operatively associated with either or both of the high-pressure EGR system 170 and the low-pressure EGR system 180 by way of an EGR control 230 associated with the adjustable EGR valves 174, 184. The controller 200 can thereby adjust the amount of exhaust gasses and the ratio of intake air/exhaust gasses introduced to the combustion process. In addition to controlling the EGR system, the controller can also be communicatively linked to a SCR injector control 246 associated with the SCR injector 196 to adjustably control the timing and amount of reductant agent introduced to the exhaust gasses.

To control the amount and/or timing of the fuel charges, the controller 200 can communicate with injector controls 240 that can control the fuel injectors 120 operatively associated with the combustion chambers 106. The injector controls 240 can selectively activate or deactivate the fuel injectors 120 to adjust the timing of introduction and the quantity of fuel introduced by each fuel injector. To further control the timing of the combustion operation, the controller 200 in the illustrated embodiment can also communicate with a camshaft control 242 that is operatively associated with the camshaft 148.

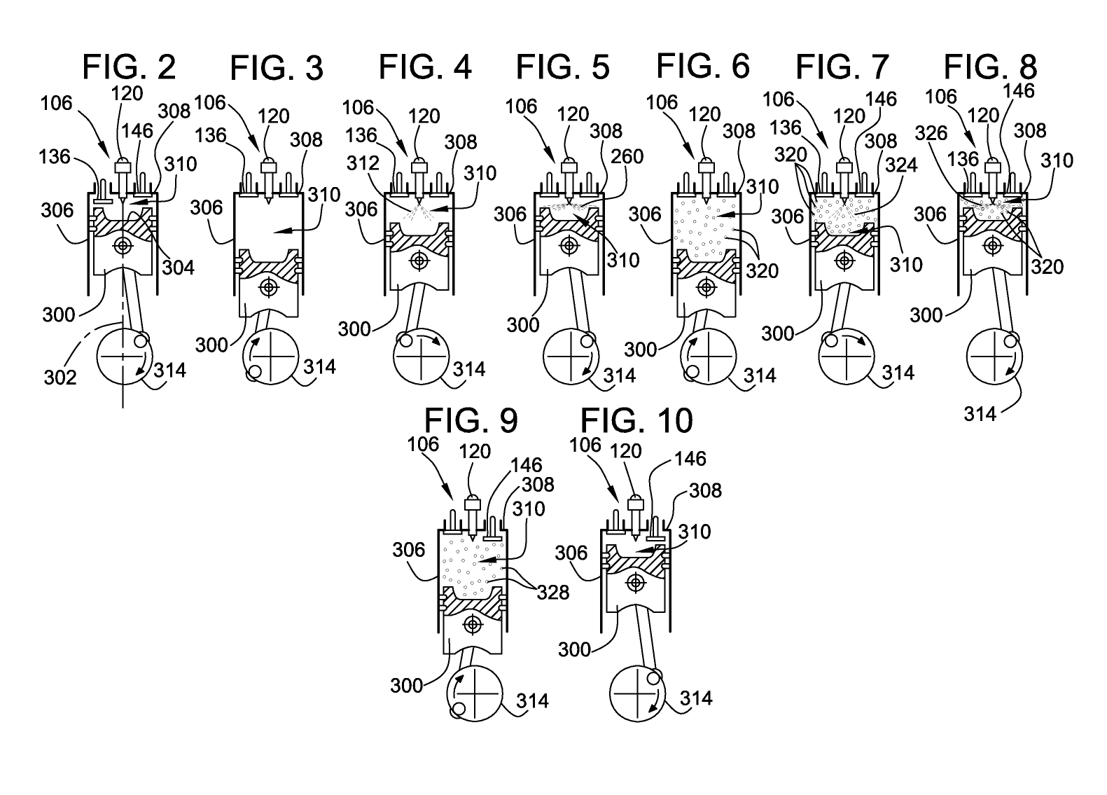

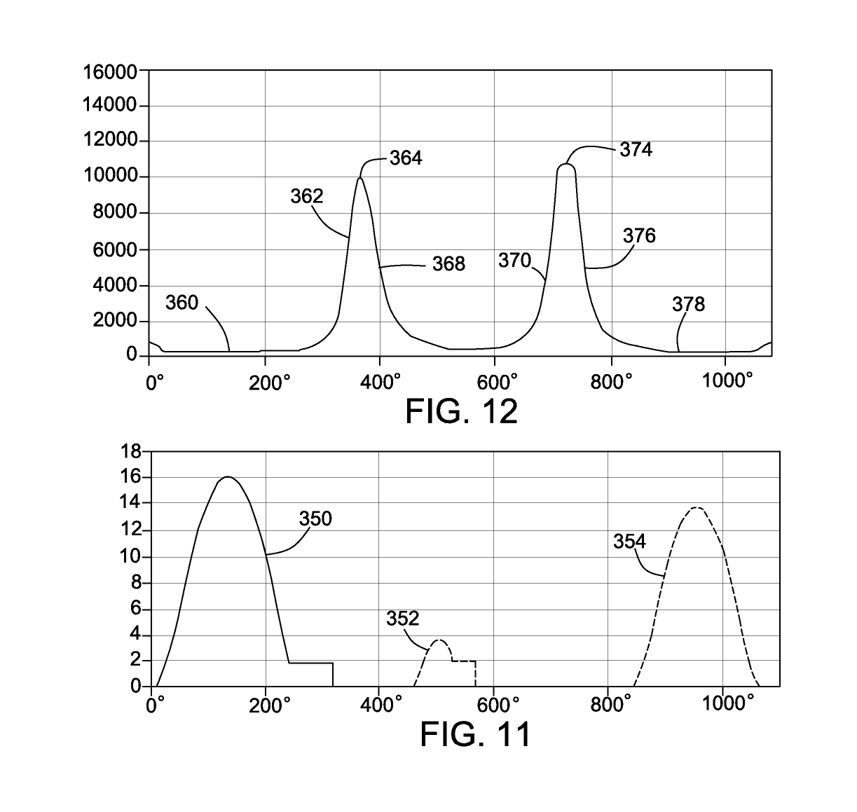

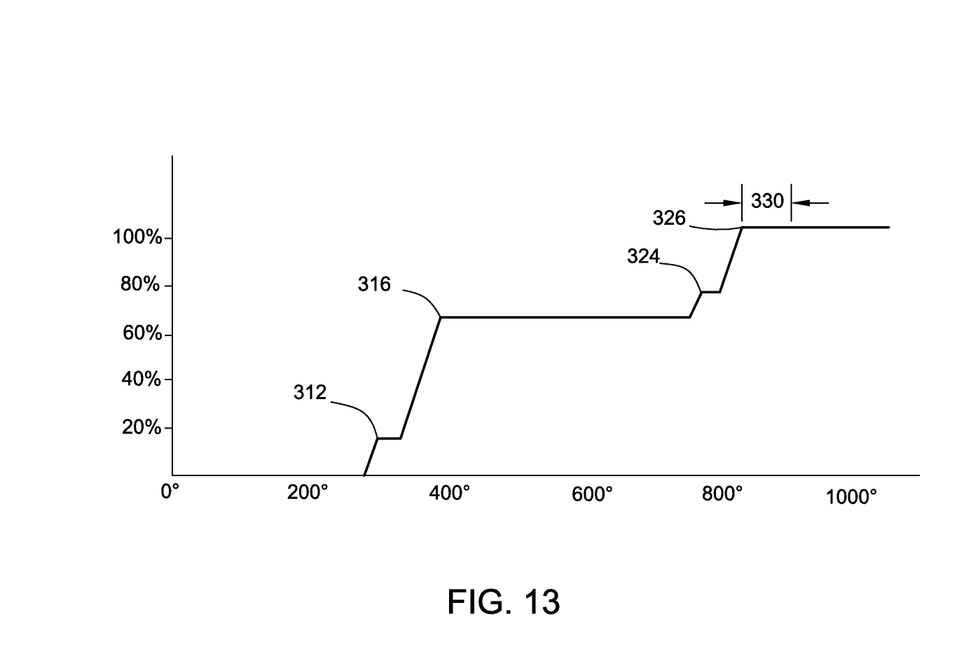

The engine system 100 can operate in accordance with a six-stroke combustion cycle in which a reciprocal piston disposed in the combustion chamber makes six or more strokes between the top dead center (TDC) position and bottom dead center (BDC) position during each cycle. A representative series of six strokes and the accompanying operations of the engine components associated with the combustion chamber 106 are illustrated in FIGS. 2-10. FIG. 11 is a chart showing the valve lift in millimeters along the Y-axis compared to the crank angle in degrees along the X-axis. Lift of the intake valve is indicated in solid lines and lift of the exhaust valve in dashed lines. FIG. 12 depicts the cylinder pressure in kilopascals (kPa) along the Y-axis compared to crank angle in degrees along the X-axis. FIG. 13 represents the quantity of the different fuel charges introduced at various points in the six-stroke cycle relative to the total quantity of fuel combusted at completion of the cycle. The fuel charges in FIG. 13 are depicted as angled, non-vertical lines to account for the finite time-period during which the fuel injector actually introduces the fuel quantity. Additional strokes, for example, 8-stroke or 10-stroke cycles, that would include one or more successive recompressions, are not discussed herein but are contemplated as within the scope of the disclosure.

The actual strokes are performed by a reciprocal piston 300 that is slidably disposed along a longitudinal axis 302 defined by an elongated cylinder 306. The cylinder 306 can be bored into an engine block, or may alternatively be disposed in a cylindrical sleeve installed into the cylinder block. Disposed in the top surface of the piston 300 can be a concaved bowl 304. One end of the cylinder 306 is closed off by a flame deck surface 308 so that the combustion chamber 106 defines an enclosed space between the piston 300, the flame deck surface and the inner wall of the cylinder. Disposed through the flame deck surface 308 can be the fuel injector 120 and the intake and exhaust valve 136, 146, although in other embodiments these components can be disposed through other portions of the combustion chamber 106. The reciprocal piston 300 moves between the TDC position where the piston is closest to the flame deck surface 308 and the BDC position where the piston is furthest from the flame deck surface. The motion of the piston 300 with respect to the flame deck surface 308 thereby defines a variable volume 310 that expands and contracts.

Referring to FIG. 2, the six-stroke cycle includes an intake stroke during which the piston 300 moves from the TDC position to the BDC position causing the variable volume 310 to expand. During this stroke, the intake valve 136 is opened so that air or an air mixture may enter the combustion chamber 106, as represented by the positive bell-shaped intake curve 350 indicating intake valve lift in FIG. 11. Also during this stroke, the pressure in the cylinder 306 may be low relative to that of the intake manifold, as indicated by low, flat intake curve 360 in FIG. 12, so that intake air is drawn or forced into the expanding variable volume 310. Referring to FIG. 3, once the piston 300 reaches the BDC position, the intake valve 136 closes and the piston can perform a first compression stroke moving back toward the TDC position and compressing the variable volume 310 that has been filled with air during the intake stroke.

As illustrated in FIG. 3 while the piston 300 moves toward the TDC position and the pressure rises in the cylinder 306, the fuel injector 120 can introduce a first preliminary fuel charge 312 to the variable volume 310. The first preliminary fuel charge 312 can be a portion of the total fuel introduced and combusted during the six-stroke cycle. For example, referring to FIG. 13, the first preliminary fuel charge 312 can be about 20% of the total fuel, by volume and/or mass, that will be introduced over the cycle. Moreover, the first preliminary fuel charge 312 can be introduced at an instance when the piston 300 is still far enough from the flame deck surface 308 that the pressure in the cylinder 306 is still relatively low. For example, the first preliminary fuel charge 312 can be introduced when the crankshaft 314 has moved through about 300° of rotation from the initial TDC position of the piston 300 shown in FIG. 2. The first preliminary fuel charge 312 may therefore have time to disperse uniformly and intermix with the intake air present in the variable volume 310.

The continued upward motion of the piston 300 toward the flame deck surface 308 increases pressure and temperature in the combustion chamber 106, indicated by the upward slope of the first compression curve 362 in FIG. 12. In diesel engines, the compression ratio can be on the order of 15:1, although other compression ratios are common. Referring to FIG. 5, as the piston 300 approaches the TDC position, the fuel injector 120 can introduce a first main fuel charge 316 into the variable volume 310 to increase the amount of fuel therein. As represented in FIG. 13, this indicates that the main fuel charge 316 can be introduced at about 350° of crank angle rotation with the understanding that the TDC position occurs at 360°. The quantity of the main fuel charge 316 can be larger than that of the first preliminary fuel charge 312. For example, the main fuel charge can introduce between about 50% and about 55% of the total fuel consumed during the cycle.

Moreover, the quantity of the first main fuel charge 316 can be such that the resulting air/fuel mixture even with the preliminary fuel charge 312 is lean of stoichiometric, meaning there is an excess amount of oxygen from what is theoretically required to fully combust the quantity of fuel that was provided to the combustion chamber. Under stoichiometric conditions, the proportion of air and fuel is such that all air and fuel will react together with little or no remaining excess of either component. For diesel fuel, the air/fuel ratio at stoichiometric conditions is about 14.5:1 to about 14.7:1. A rich condition is the corollary in which excess fuel is present. In the disclosed six-stroke embodiment, the air/fuel ratio created by the first preliminary fuel charge 312 and the main fuel charge 316 can be between 20:1 to 40:1 to produce a first stoichiometric lean condition depending on the portion of the total fuel that will be provided for the first combustion.

When the first main fuel charge 316 is introduced and the pressure and temperature in the cylinder are at or near a first maximum pressure, as indicated by point 364 in FIG. 12, the air/fuel mixture may spontaneously ignite. In embodiments where the fuel is less reactive, i.e., the fuel has a lower propensity to auto-ignite when pressurized and heated, such as in gasoline burning engines, ignition may be initiated with a sparkplug or the like. At ignition, the main fuel charge 316 may be less uniformly dispersed in the cylinder 306 than the preliminary fuel charge 312, resulting in combustion propagating through the variable volume 310 at different rates and flame temperatures. As indicated in FIGS. 5 to 6, the combusting air/fuel mixture expands forcing the piston 300 back to the BDC position producing a first power stroke. The piston 300 can be linked or connected to the crankshaft 314 so that its linear motion is converted to rotational motion that can be used to power an application or machine. The expansion of the variable volume 310 during the first power stroke also reduces the pressure in the combustion chamber 106 as indicated by the downward sloping first expansion curve 368 in FIG. 12. At this stage, the variable volume 310 contains the resulting combustion products 320 that may include unburned fuel in the form of hydrocarbons, even though the air/fuel mixture in the chamber was lean (due to incomplete combustion). The variable volume 310 may further include carbon monoxide, nitrogen oxides such as NO and NO₂ commonly referred to as NO_{X}, and excess oxygen from the intake air due to the lean conditions.

Referring to FIG. 7, in the six-stroke cycle after completion of the first power stroke, the piston 300 can again move toward the TDC position to perform another compression stroke in which it compresses the combustion products 320 in the variable volume 310. During the second compression stroke, both the intake valve 136 and exhaust valve 146 are typically closed so that pressure increases in the variable volume as indicated by the second compression curve 370 in FIG. 12. However, in some embodiments, to prevent too large a pressure spike, the exhaust valve 146 may be briefly opened to discharge some of the contents in a process referred to as blowdown, as indicated by the small blowdown curve 352 in FIG. 11. During this time, the fuel injector can introduce a second preliminary fuel charge 324 to the combustion chamber 106 to uniformly intermix with the combustion products 320 from the previous combustion event. As indicated in FIG. 13, the second preliminary fuel charge 324 can occur at about 700 degrees of crank angle with a quantity of about 10% to 15% of the total fuel consumption.

As shown in FIG. 8, about the time when the piston 300 reaches the TDC position, the fuel injector 120 can introduce a second main fuel charge 326 into the combustion chamber 106. More specifically, as indicated in FIG. 13, the second main fuel charge 326 can be introduced within a range of crank angles between about 700 to about 750° so as to be slightly before or after the TDC position occurring at 720°. The second main fuel charge 326 can introduce the remaining 15% or so of the total fuel charge. In an embodiment, the quantity of the second main fuel charge 326 provided to the cylinder 306, in conjunction with oxygen that may remain within the cylinder and the second preliminary fuel charge, can be selected to approach the stoichiometric condition for combustion but still be slightly lean of stoichiometric. For example, the air/fuel ratio resulting from the second main fuel charge 326 can be between about 14.7:1 and about 22:1 and, more precisely, between about 17:1 and about 20:1, so as to produce a second stoichiometric lean condition that, although lean, is still closer to stoichiometric than the first stoichiometric lean condition.

Referring to FIG. 12, at the instance of the second main fuel charge, the pressure in the compressed variable volume 310 caused by the moving piston 300 may be at a second maximum pressure 374 or may be slightly falling from the second maximum pressure. Under such elevated pressure and temperature conditions, the second main fuel charge 326 may spontaneously ignite upon introduction to the combustion chamber 106 to combust the second preliminary fuel charge and the previous combustion products 320. In an alternative embodiment, the second preliminary fuel charge may have already ignited and be undergoing combustion to thereby ignite the second main fuel charge 326 upon introduction. Referring to FIGS. 8 to 9, the second ignition and resulting second combustion expands the contents of the variable volume 310 forcing the piston 300 toward the BDC position resulting in a second power stroke driving the crankshaft 314. The second power stroke also reduces the pressure in the cylinder 306 as indicated by the downward slopping second expansion curve 376 in FIG. 12.

The second combustion event can further incinerate the unburned combustion products from the initial combustion event such as particulate matter, unburned fuel and soot. The quantity or amount of hydrocarbons in the resulting second combustion products 328 remaining in the cylinder 306 may accordingly be reduced. Referring to FIG. 10, an exhaust stroke can be performed during which the momentum of the crankshaft 314 moves the piston 300 back to the TDC position with the exhaust valve 146 opened to discharge the second combustion products to the exhaust system. With the exhaust valve opened as indicated by the bell-shaped exhaust curve 354 in FIG. 11, the pressure in the cylinder can return to its initial pressure as indicated by the low, flat exhaust pressure curve 378 in FIG. 12. Alternatively, additional recompression and re-combustion strokes can be performed in accordance with an 8-stroke, 10-stroke or like operating mode of the engine.

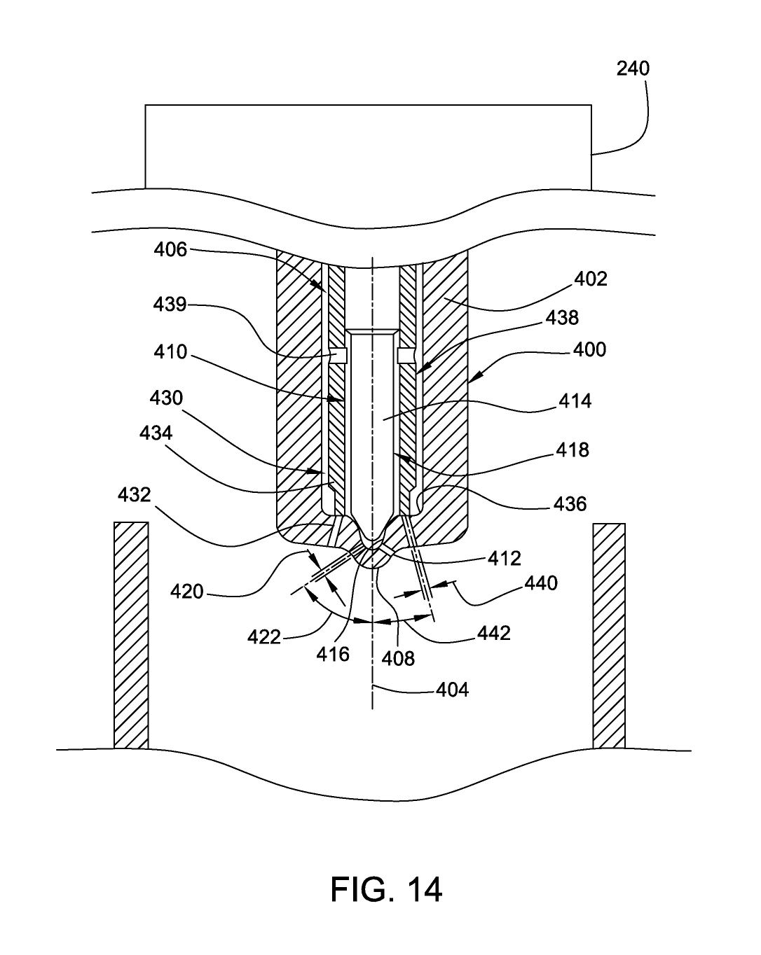

Referring to FIG. 14, there is illustrated an embodiment of a fuel injector 400 configured for introducing the first and second preliminary and main charges to the combustion chamber. The illustrated embodiment is a dual-check fuel injector 400 that introduces fuel through two different sets of orifices at different flow rates or volumes. The dual-check injector 400 includes an elongated, rod-like body 402 that extends generally along an injector axis line 404. The body 402 is substantially hollow so as to define an interior void 406 also aligned along the axis line 404 with one end of the body closed off by a distal wall 408. Disposed inside the interior void 406 are a first, inner check 410 and a second, outer check 430 arranged in a concentric manner and that can operate independent of each other to selectively open and close a first orifice set 412 and a respective second orifice set 432. In an alternative embodiment, the two checks may be disposed adjacent one another instead of concentrically, while in yet another alternative embodiment, two separate fuel injectors may be associated with a single cylinder.

More specifically, to open and close the first orifice set 412, the first inner check 410 includes a first valve member 414 movable along the axis line 404 that can reciprocally move against and/or away from a first valve seat 416 disposed along the inner surface of the distal wall 408. The first orifice set 412 is disposed through the distal wall 408 and the first valve seat 416 and arranged in a manner that aligns the orifice or orifices with the distal end of the first valve member 414. Likewise, to open and close the second orifice set 432, the second outer check 430 can include a second valve member 434 movable along the axis line 404 and that can reciprocate against and/or away from a second valve seat 436 disposed on the inner surface of the distal wall 408 through which the second orifice or orifices 432 are disposed. The second valve member 434 can be formed as a hollow tube to accommodate the smaller diameter first valve member 414 within an inner lumen 418. Similarly, the second valve member 434 is loosely accommodated in the interior void 406 and sized to create a second outer lumen 438. The inner and outer lumens 418, 438 can channel or direct fuel parallel to the axis line 404 to the respective first and second orifice sets 412, 432. Further, to direct fuel to the inner lumen 418 from the outer lumen 438, one or more transverse apertures 439 can be disposed through the second valve member 434 perpendicularly to the axis line 404. Independent reciprocal motion between the first and second valve members 414, 434 can be actuated by the injector controller 240 coupled to the fuel injector 400.

To produce the different fuel charges differentiated by, for example, volumetric fuel quantity or spray pattern, the first and second orifice sets 412, 432 can each include one or more orifices disposed through the distal wall 408 to communicate with the fuel-filled, interior void 406 when the respective first and second valve members 414, 434 are retracted. In the illustrated embodiment, the first orifice set 412 can include a plurality of orifices, for example between five and nine orifices, disposed in a concentric circle around the axis line 404. The second orifice set 432 can include another plurality of orifices also disposed concentrically around the axis line 404 and outwardly of the first orifice set 412. The orifices of the first orifice set 412 can have or define a first diameter or cross-sectional area 420 that is larger than the orifices of the second orifice set 432 that may have or define a smaller second diameter or cross-sectional area 440. Accordingly, the controller can selectively open and close the first and second orifices sets 412, 432 independently or in combination with each other to produce the first and second main and preliminary fuel charges. In a specific embodiment, to produce the larger first main fuel charge, both the first and second sets of orifices 412, 432 are opened, while to produce the smaller second main fuel charge only the larger diameter, first orifice set is opened and to produce the smaller preliminary fuel charges only the smaller second orifice set is opened.

In another embodiment, to produce different spray patterns, the first and second orifice sets 412, 432 can be disposed into the distal wall 408 of the body 402 at different angles with respect to the axis line 404. For example, the orifices of the first orifice set 412 can be each disposed at a first angle 422 relative to the axis line 404 while the orifices of the second set 432 are disposed at a second angle 442. The first angle 422 can be larger or smaller than the second angle 442 so that the resulting first spray pattern can be wider or narrower than the second spray pattern. If the first and second orifice sets are arranged concentrically around the axis line, it may be appreciated that the first and second spray patterns will be generally conical, but in other embodiments, other spray patterns are contemplated.

### INDUSTRIAL APPLICABILITY

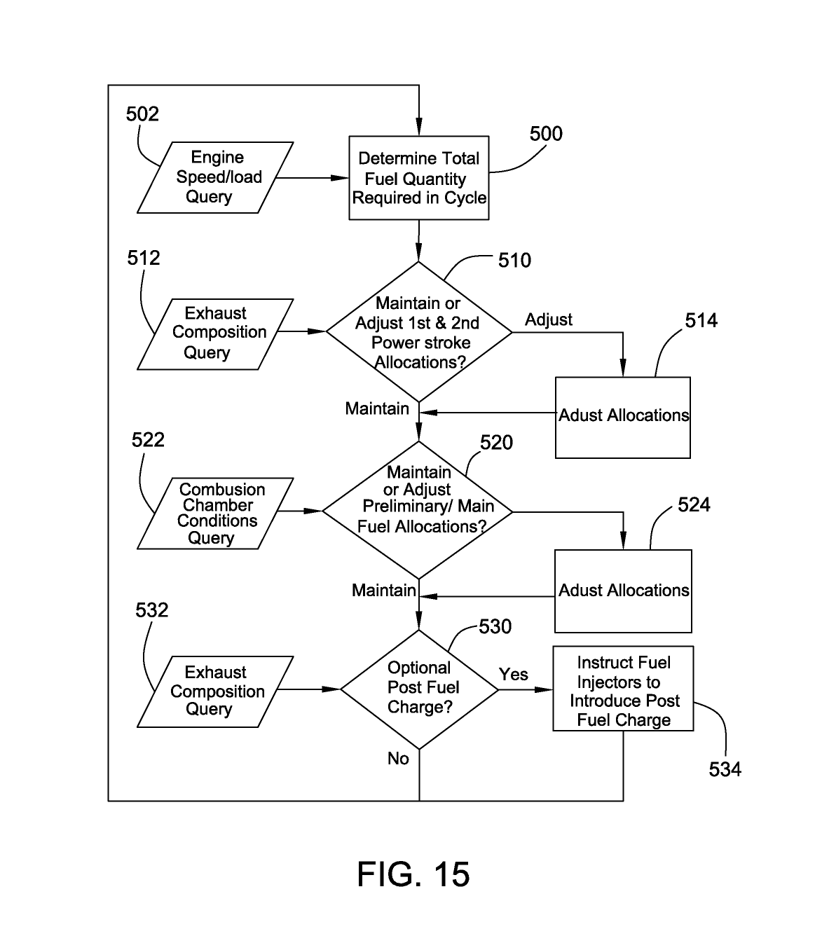

The present disclosure is applicable to internal combustion engines operating on a six-stroke cycle using preliminary and main fuel charges to introduce fuel to the combustion chamber. Referring to FIG. 15, there is illustrated a representative series of steps and actions a controller directing a fuel injector can perform in accordance with preliminary and main fuel charges or injection events depicted in FIG. 13. In a first determination step 500, the controller determines the total amount of fuel to be combusted during the six-stroke cycle, which in turn is part of the aggregate total fuel demand of the internal combustion engine at a given time. For example, for a compression ignition diesel engine, the total fuel demand generally directly relates to the engine speed and/or engine load. Therefore, to help determine the total fuel amount required for the six-stroke cycle, the controller can, in a first query step 502, can communicate with other sensors to receive engine speed or engine load data. Based on this data, the controller can readily determine the 100% fuel requirement depicted in FIG. 13.

The controller in a first decision step 510 can decide the quantities of fuel to allocate to the first and second combustion events and power strokes. The controller can base this determination in part upon the desire to reduce emissions such as particulate matter, nitrogen oxides (NO_{X}) and soot. Specifically, the quantity and timing of the second fuel charge can burn a certain amount of soot and particulate matter remaining in the combustion products from the first fuel charge. To assist the first decision step, the controller in a second query step 512 can communicate with sensors such as those disposed in the exhaust system to receive data regarding the amount of particulate matter and/or soot the engine is presently producing. The controller can decide if the emissions are at an acceptable level and accordingly adjust or maintain the first and second fuel charges. If adjustment is necessary, the controller can proceed to an intermediary adjustment step 514 to decide what adjustment should be made to fuel allocation by, for example, using maps, charts or other predetermined information that may be stored in memory.

The controller in a second decision step 520 can decide further the allocation of fuel quantities between preliminary fuel charges and main fuel charges. In part, this allocation can further reduce particulate matter and assist in balancing the engine to maintain maximum pressure levels in the combustion chamber within acceptable limits, thereby avoiding blow-by or other negative effects of over-pressurization. For example, introducing fuel in a preliminary fuel charge may better distribute fuel in the combustion chamber and improve localized air/fuel ratios during combustion that may assist in reducing soot formation. A preliminary fuel charge may also advance ignition by auto-igniting and combusting into exhaust gasses prior to the main fuel charge. The preliminary fuel charge thus acts as an internal EGR system establishing an exhaust gas/intake air mixture in the combustion chamber prior to the main fuel charge that lowers the relative oxygen concentration and lowers combustion temperatures to reduce the generation of nitrogen oxides. This may be especially beneficial during the first stoichiometric lean condition established by the first main fuel charge.

As a further example, the controller may introduce the second main fuel charge late after the cylinder has reached the maximum pressure. This may be combined with an intermediate blowdown event between the first power stroke and second compression stroke to release some of the initial combustion products in the cylinder. Referring to FIG. 12, these adjustments may lower the second maximum pressure 374 evenly balancing it with the first maximum pressure 364 to reduce engine vibrations or rattling. To assist in making the second decision, the second decision step 520 in a third query step 522 can receive data from the chamber sensors regarding cylinder pressures. If controller determines adjustment is necessary to rebalance the engine pressures, the controller can proceed to a second adjustment step 524 to decide how to reallocate fuel between preliminary and main fuel charges, for example, again by using maps, charts or other predetermined information that may be stored in memory.

To further reduce soot and like, the routine can perform an optional third decision step 530 on whether to introduce a post fuel charge during the second power stroke after the second main fuel charge. Referring to FIG. 13, the post fuel charge, indicated by arrow 330, can occur at crank angles between about 750° and about 850°. The quantity of fuel in the post fuel charge can be relatively small, for example, corresponding to the minimal amounts set by the fuel injector duration limitations, and can be formed from a delayed fraction of the second main fuel charge 326 or can be additional fuel added to the total fuel charge. The post fuel charge 330 can prolong combustion during the second power stroke as the variable volume expands and pressures and temperatures drop to continue incineration of the combustion products. To assist in assessing the applicability of a post fuel charge, in a fourth query step 532, the controller can receive exhaust gas composition data from the sensors disposed in the exhaust system and, if affirmative, can issues appropriate instructions 534 to the fuel injectors.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A method of operating an internal combustion engine on a six-stroke cycle including a intake stroke; a first compression stroke, a first power stroke, a second compression stroke, a second power stroke and an exhaust stroke, the method comprising:
introducing a first preliminary fuel charge to a combustion chamber of the internal combustion engine during the first compression stroke;
introducing a first main fuel charge to the combustion chamber during at least one of the first compression stroke and the first power stroke subsequent to the first preliminary fuel charge;
combusting the first preliminary fuel charge and the first main fuel charge to power the first power stroke;
introducing a second preliminary fuel charge to the combustion chamber during the second compression stroke;
introducing a second main fuel charge to the combustion chamber during at least one of the second compression stroke and the second power stroke subsequent to the second preliminary fuel charge; and
combusting the second preliminary fuel charge and the second main fuel charge to power the second power stroke.

2. The method of claim 1, wherein the combustion chamber includes a piston movable in a cylinder, the piston operatively connected to a rotatable crankshaft, the crankshaft rotating from 0 degrees at the start of the intake stroke to 1080 degrees at the conclusion of the exhaust stroke.

3. The method of claim 2, wherein the first preliminary fuel charge is introduced at about 300 degrees of crankshaft rotation and the first main fuel charge is introduced at about 350 degrees of crankshaft rotation.

4. The method of claim 3, wherein the second preliminary fuel charge is introduced at about 700 degrees of crankshaft rotation and the second main fuel charge is introduced at about 750 degrees of crankshaft rotation.

5. The method of claim 1, further comprising introducing a post fuel charge during the second power stroke subsequent to the second main fuel charge.

6. The method of claim 1, wherein a sum of the first preliminary fuel charge, the first main fuel charge, the second preliminary fuel charge and the second main fuel charge is a total fuel amount for the six-stroke cycle.

7. The method of claim 6, wherein the first preliminary fuel charge introduces about 20% of the total fuel amount, the first main fuel charge introduces about 55% of the total fuel amount, the second preliminary fuel charge introduces about 10% of the total fuel amount, and the second main fuel charge introduces about 15% of the total fuel amount.

8. The method of claim 1, further comprising an exhaust sensor disposed in an exhaust system associated with the internal combustion engine to direct exhaust gasses from the combustion chamber, the exhaust sensor sensing exhaust gas composition.

9. The method of claim 8, wherein amounts of fuel introduced during the first preliminary fuel charge, the first main fuel charge, the second preliminary fuel charge, and the second main fuel charge are determined in part based on exhaust gas composition.

10. An internal combustion engine system operating on a six-stroke cycle including an intake stroke, a first compression stroke, a first power stroke, a second compression stroke, a second power stroke, and an exhaust stroke, the engine comprising
a combustion chamber including a cylinder and a piston reciprocally disposed in the chamber to move between a top dead center position (TDC) and a bottom dead center position (BDC);
a rotatable crankshaft operatively connected to the piston, the crankshaft rotating between 0 degrees at the start of the intake stroke and 1080 degrees at the end of the exhaust stroke;
a fuel injector in fluid communication with the combustion chamber to introduce fuel;
a controller operatively associated with the internal combustion engine, the controller controlling the injector to introduce a first preliminary fuel charge and a first main fuel charge during the first compression stroke, to introduce a second preliminary fuel charge during the second compression stroke, and to introduce a second main fuel charge during at least one of the second compression stroke and the second power stroke.

11. The system of claim 10, wherein the first preliminary fuel charge is introduced at about 300 degrees of crankshaft rotation and the first main fuel charge is introduced at about 350 degrees of crankshaft rotation.

12. The system of claim 10, wherein the second preliminary fuel charge is introduced at about 700 degrees of crankshaft rotation and the second main fuel charge is introduced at about 750 degrees of crankshaft rotation.

13. The system of claim 10, wherein the controller further controls the fuel injector to introduce a post fuel charge during the second power stroke subsequent to the second main fuel charge.

14. The system of claim 10, further comprising an exhaust sensor disposed in an exhaust system associated with the internal combustion engine to direct exhaust gasses from the combustion chamber, the exhaust sensor sensing exhaust gas composition.

15. The system of claim 10, wherein the controller communicates with the exhaust sensor, the controller further adjusting relative quantities of fuel introduced during the first preliminary fuel charge, the first main fuel charge, the second preliminary fuel charge, and the second main fuel charge based in part on exhaust gas composition.

16. A method of balancing first and second combustion events in an internal combustion engine operating on a six stroke cycle including an intake stroke, a first compression stroke, a first combustion event and a first power stroke, a second compression stroke, a second combustion event and a second power stroke, and an exhaust stroke, the method comprising:
providing a combustion chamber having a piston reciprocally movable in a cylinder between a top dead center position and a bottom dead cylinder position;
introducing a first main fuel charge to the combustion chamber during the first compression stroke before the piston reaches the TDC position;
introducing a second preliminary fuel charge to the combustion chamber during the second compression stroke before the piston reaches the TDC position; and
introducing a second main fuel charge to the combustion chamber during the second power stroke after the piston reaches the TDC position.

17. The method of claim 16, wherein the second preliminary fuel charge ignites prior to the second main fuel charge.

18. The method of claim 16, further comprising introducing a first preliminary fuel chart to the combustion chamber during the first compression stroke prior to the step of introducing the first main fuel charge.

19. The method of claim 18, wherein the piston is operatively connected to rotatable crankshaft, the crankshaft rotating from 0 degrees at the start of the intake stroke to 1080 degrees at the conclusion of the exhaust stroke; and
wherein the first preliminary fuel charge is introduced at about 300 degrees of crankshaft rotation and the first main fuel charge is introduced at about 350 degrees of crankshaft rotation; and wherein the second preliminary fuel charge is introduced at about 700 degrees of crankshaft rotation and the second main fuel charge is introduced at about 750 degrees of crankshaft rotation.

20. The method of claim 16, further comprising introducing a post fuel charge during the second power stroke subsequent to the second main fuel charge
